(19) United States
(12) Patent Application Publication
(10) Pub. No.: US 2009/0096614 A1
(43) Pub. Date: Apr. 16, 2009

(54) RFID POWER BRACELET AND METHOD FOR MANUFACTURING A RFID POWER BRACELET

(75) Inventors: Robert W. Singleton, Lakeland, FL (US); Lawrence J. Keim, Lakeland, FL (US)

Correspondence Address: FOLEY AND LARDNER LLP;SUITE 500, 3000 K STREET NW, WASHINGTON, DC, 20007, US

(73) Assignee: INNOVATIER, INC.

(21) Appl. No.: 11/872,357

(22) Filed: Oct. 15, 2007

(51) Int. Cl. G08B 13/14

(52) U.S. Cl. 340/572.8

(57) ABSTRACT

A RFID power bracelet and a method for manufacturing the same is provided. The bracelet is composed of a bottom layer having a top surface and a bottom surface, a power source attached to the top surface of the bottom layer, a core layer, positioned above the bottom layer and attached to the bottom layer and a top layer, positioned above the core layer, wherein the top layer is configured to receive a detachable electronic package capable of operatively connecting to the power source.

### BACKGROUND OF THE INVENTION

Electronic bracelets have numerous applications from functional to fashionable. For example, an electronic bracelet may be used as a ticket to indicate that the wearer of the bracelet is entitled to admittance to a venue or show. An electronic bracelet is ideal in cases where vigorous physical activity is involved or where it is burdensome for a patron to keep up with a ticket, such as a water park or concert. Radio frequency identification (“RFID”) chips may be incorporated into electronic bracelets to give them increased functionality. Generally, RFID chips are used for tracking products. An item possessing a RFID chip may be tracked by a network system. Because of the RFID, the network system is able to identify the location of the RFID chip and thus the wearer of the electronic bracelet.

Generally, in bracelets possessing a RFID chip, the electronics and power source are typically packaged using an outer casing which is ultrasonically welded or potted to secure the electronic package. This method of manufacturing does not allow for replacement of the power source thus rendering the electronic package useless prematurely. Therefore, a power bracelet and method for manufacturing a power bracelet with detachable and/or disposable functionality is needed to provide power to an electronics package so that the electronics package can be reused on a continual basis.

### SUMMARY OF THE INVENTION

According to one embodiment, A power bracelet includes a bottom layer having a top surface and a bottom surface, a power source attached to the top surface of the bottom layer, a core layer, positioned above the bottom layer and attached to the bottom layer and a top layer, positioned above the core layer, wherein the top layer is configured to receive a detachable electronic package capable of operatively connecting to the power source.

According to another embodiment, the electronic package includes a housing, wherein the housing encloses an antenna and a radio frequency identification microprocessor operably connected to the antenna. The electronic package further includes a plurality of contacts for operably connecting the electronic package to the power source.

According to yet another embodiment of the invention, a method for manufacturing a power bracelet includes the steps of providing a bottom layer having a top surface and a bottom surface, attaching a power source to the top surface of the bottom layer, loading the bottom layer into an injection molding apparatus, loading the top layer, positioned above the top surface of the bottom layer, into the injection molding apparatus and injecting thermosetting polymeric material between the top layer and the top surface of the bottom layer.

According to still another embodiment of the invention, the method for manufacturing a power bracelet also includes the step of attaching an electronic package to the top layer, wherein the electronic package is operably connected to the power source so that the electronic package receives power from the power source.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims and the accompanying exemplary embodiments shown in the drawings, which are briefly described below.

FIG. 1 is a top cross sectional view of a RFID power bracelet according to one embodiment.

FIG. 2 is a side cross sectional view of a power bracelet according to another embodiment.

FIG. 3 is a side cross sectional view of a power bracelet in an injection molding apparatus prior to injection of a core layer according to one embodiment.

FIG. 4 is a top view of a power bracelet according to one embodiment.

FIG. 5 is a side view of an electronic package according to one embodiment.

FIG. 6 is a side view of an electronic package according to one embodiment.

FIG. 7 is a cross sectional view of an electronic package according to one embodiment.

### DETAILED DESCRIPTION

Embodiments of the present invention will be described below with reference to the accompanying drawings. It should be understood that the following description is intended to describe exemplary embodiments of the invention, and not to limit the invention.

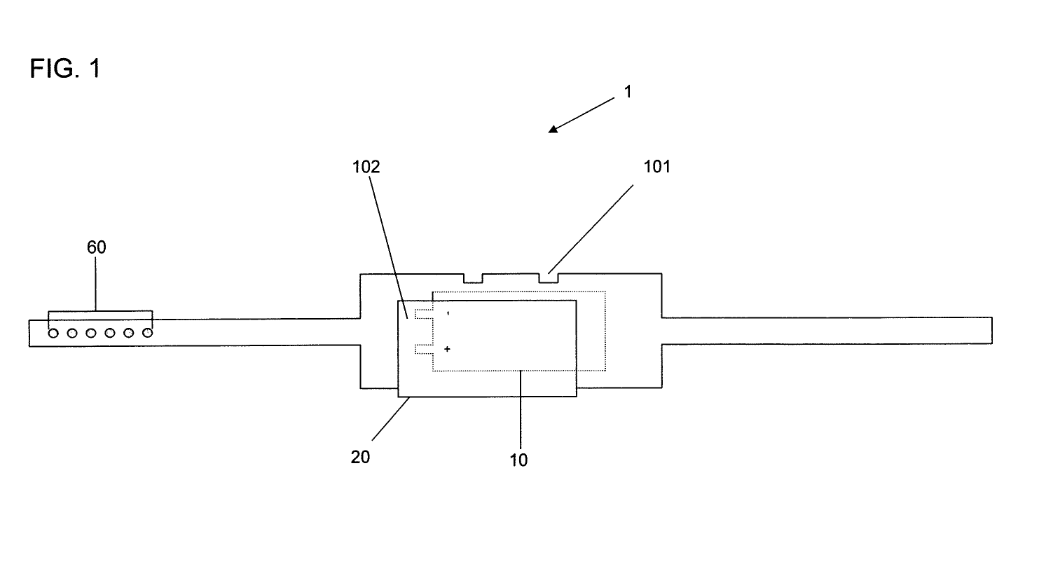

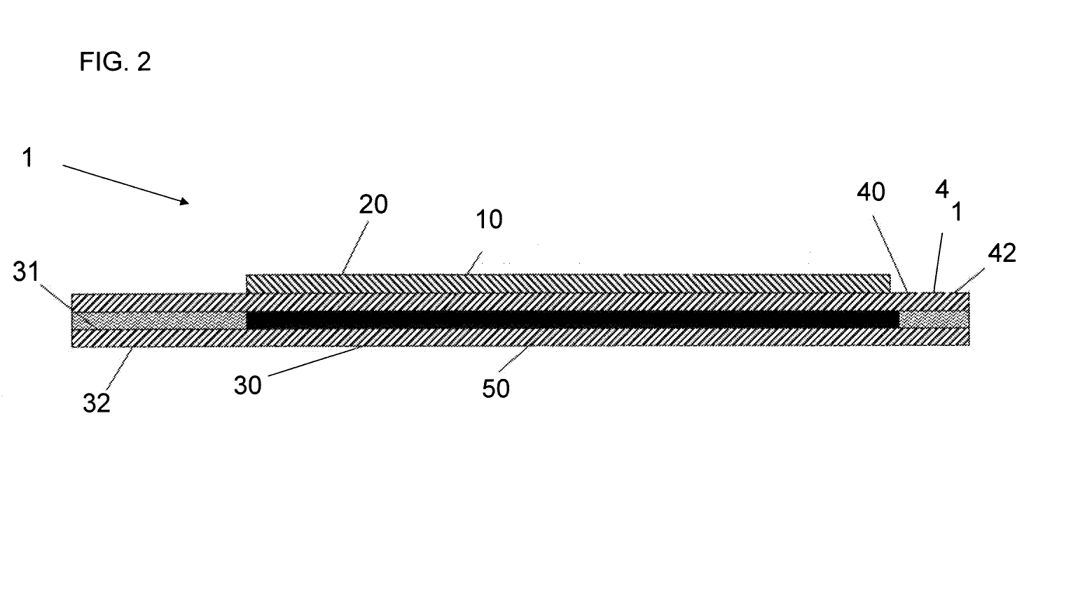

According to one embodiment, as shown in FIGS. 1 and 2, the power bracelet 1 comprises an embedded power source 10, a detachable electronic package 20, a bottom layer 30, a top layer 40 and a core layer 50. In addition, the power bracelet 1 includes registration recesses 101 which are used to orient the electronic package onto the top layer 40 in the correct position. As shown, the power bracelet 1 also includes extremity loops 60 for fastening the bracelet 1 to the wrist of a wearer.

The bottom layer 30 has a top surface 31 and a bottom surface 32. The bottom layer 30 is comprised of any known conventional plastic material that does not conduct electricity. For example, the bottom layer 30 may be comprised of PVC, nylon, polyester, polypropylene, polycarbonate or teslin. The bottom surface 32 of the bottom layer 30 is configured to display writing or any type of identifiable marks.

A power source 10 may be embedded between the top layer 40 and the bottom layer 30. Specifically, according to one embodiment, the power source is attached to the top surface 31 of the bottom layer 30. Preferably, the power source 10 is attached to the bottom layer 30 using a pressure sensitive adhesive, cyanoacrylate or other quick set adhesive. The power source comprises contacts 102 for operably connecting to an electronic package 20. The power source 10 is configured to supply power through the contacts 102 to the electronic package 20. The power source 10 may be any one of several types of power sources. For example, the power source 10 may be a battery. Specifically, the battery may be a Varta lpf-25, solicore 4823, or lithium coin cell battery.

According to one embodiment, the power source 10 is positioned beneath the top layer but does not come into contact with the bottom surface 41 of the top layer 40. In this embodiment, pins of the electronic package 20 are capable of penetrating the top layer 40 in order to connect to the contacts 102 of the power source 10. According to another embodiment, the power source 10 comes into contact with the bottom surface 41 of the top layer 40. In this embodiment, pins of the electronic package 20 are capable of penetrating the top layer 40 in order to connect to the contacts 102 of the power source 10. In the alternative, the top layer 40 may be configured so that the contacts 102 of the power source 10 are exposed. In this embodiment, the contacts of the electronic package 20 do not have to penetrate the top layer 40.

As shown in FIG. 2, the top layer 40 has a bottom surface 41 and a top surface 42. The top layer 40 is comprised of any known conventional plastic material that does not conduct electricity. For example, the top layer 40 may be comprised of PVC, nylon, polyester, polypropylene, polycarbonate or teslin. The top surface 42 of the top layer 40 may be configured to display writing or any type of identity marks. The bottom surface 41 of the top layer 40 is configured to come into contact with a core layer 50 and portions of the power source 10.

According to one embodiment of the present invention, the top surface 41 of the top layer 40 is configured to receive a detachable electronic package 20 (shown in FIG. 1). The top layer 40 is configured so that the power source contacts 102 are exposed on the top surface 41 of the top layer 40. Further, the top layer 40 and bottom layer 30 have registration recesses 101. The registration recesses 101 are configured to mate with the registration pins 201 of the electronic package 20 to insure that the electronic package is oriented correctly on top of the top layer 41. Accordingly, the power source 10 can provide power to the electronic package 20.

The core layer 50 is positioned between the top layer 40 and bottom layer 30 and is in continuous contact with the bottom surface 42 of the top layer 40 and the top surface 31 of the bottom layer 30. The core layer 50 is comprised of material configured to stabilize the power source 10 in the vertical and horizontal directions. In addition, the core layer 50 protects the power source 10 from physical damage. The thickness of the core layer 50 is in the range of 0.005-0.100 inches. Preferably, the core layer 50 is 10% thicker than the thickness of the power source 10.

According to one embodiment of the invention, the core layer 50 is comprised of any one of a number of thermosetting polymeric materials. Due to its bonding and adhesive properties, a core thermosetting polymeric layer 50 integrates the bottom layer 30 with the top layer 40 and the power source to form a power bracelet 1.

The preferred thermosetting materials are polyurethane, epoxy and unsaturated polyester polymeric materials. Specifically, polyurethanes made by condensation reactions of isocyanate and a polyol derived from propylene oxide or trichlorobutylene oxide are preferred. Of the various polyesters that can be used, those that can be further characterized as being “ethylenic unsaturated” are particularly preferred because of their ability to be cross linked through their double bonds with compatible monomers (also containing ethylene unsaturation) and with the materials out of which the top 40 and bottom 30 layers are made. The more preferred epoxy materials for use in the practice of this invention will be those made from epichlorohydrin and bisphenol A, or epichlorohydrin and an aliphatic polyol (such as glycerol). They are particularly preferred because of their ability to bond with some of the more preferred materials (e.g., polyvinyl chloride) out of which the top 40 and bottom 30 layers may be made.

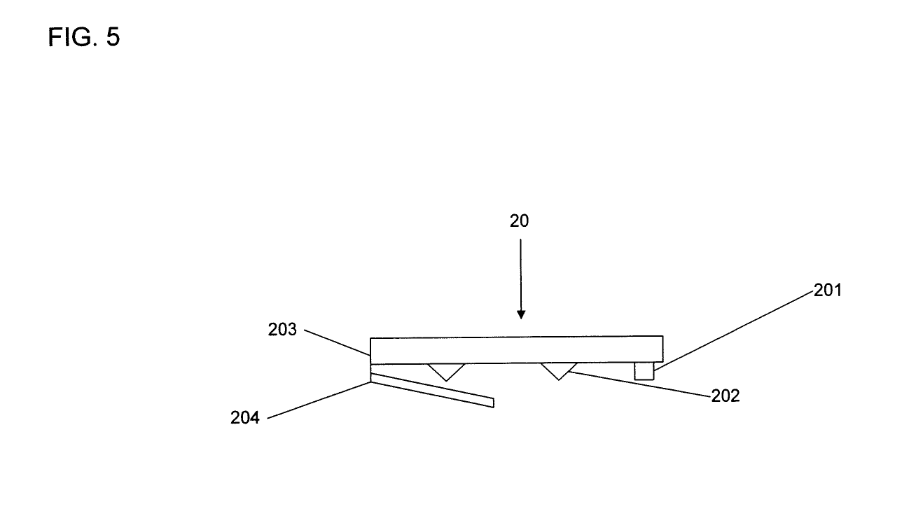

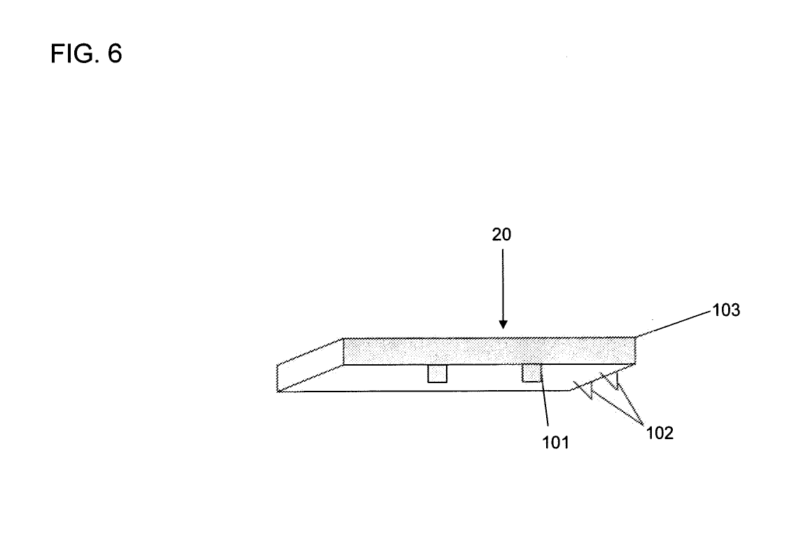

As shown in FIG. 1, FIG. 5 and FIG. 6, according to one embodiment of the invention, the detachable electronic package 20 consists of a housing 203, registration pins 201 and power contacts 202. The housing 203 encloses a plurality of circuit components. The registration pins 201 are used to guide the electronic package 20 into the appropriate position so that the electronic package 20 and the power source 10 connect correctly. Once connected, the electronic package contacts 202 interact with the power source contacts 102 of the power source 10 to power the electronic package 20.

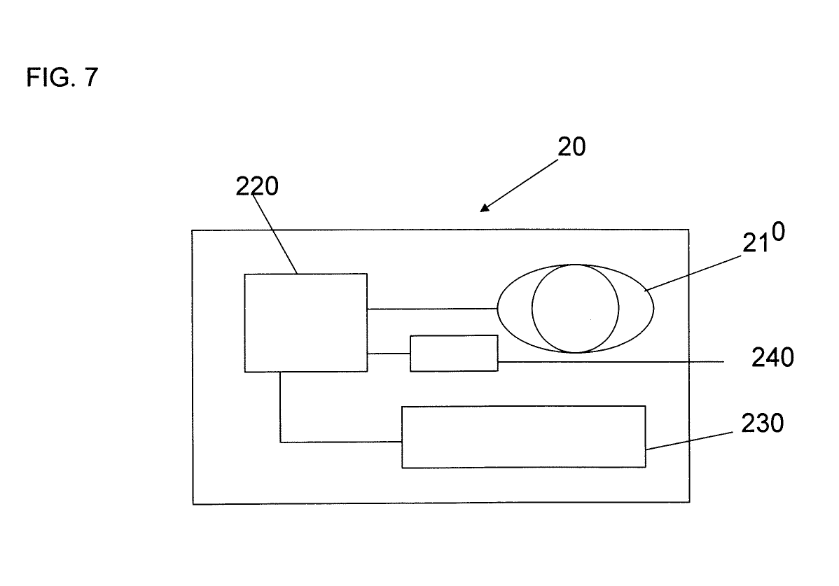

A plurality of circuit components can be positioned anywhere in the housing 203 of electronic package 20 as desired. The purpose and design functionality of the power bracelet 1 will dictate the position of the circuit components. Functionality will also dictate what types of circuit components are included within the electronic package 20. As shown in FIG. 7, for example purposes only, the electronic package 20 could be populated with an antenna 210, a RFID microprocessor 210 and a LCD display 230. In the case of the LCD 230, the electronic package is configured so that the LCD is visible to a wearer of the power bracelet 1. Further, the electronic package can include one or more circuit components 240 that may include but are not limited to programmable chips, LEDs, flexible displays, emulators, etc. The RFID microprocessor 210 may be any one of several known RFID processors. For example, a Phillips SL2 ICS20 chip may be used as the RFID microprocessor 210. In one embodiment, a FCP2 flip-chip package is used as the RFID microprocessor 210.

As shown in FIG. 5, according to one embodiment, a clip 204 connects the detachable electronic package 20 to the bottom layer 30 of the power bracelet 1. The clip 204 itself is detachable and slides on and off of the detachable electronic package 20. According to another embodiment, the electronic package does not have a clip 204. In this embodiment, shown in FIG. 6, the electronic package is attached to the top layer 40 with an adhesive. Preferably, pressure sensitive adhesive, cyanoacrylate or another quick set adhesive connects the detachable electronic package 20 to the top surface 41 of the top layer 40 of the power bracelet 1. When the electronic package 20 is attached to the power bracelet 1, the power source 10 powers the electronic components included in the electronic package 20.

A method for manufacturing a power bracelet 1 according to the present invention will now be described.

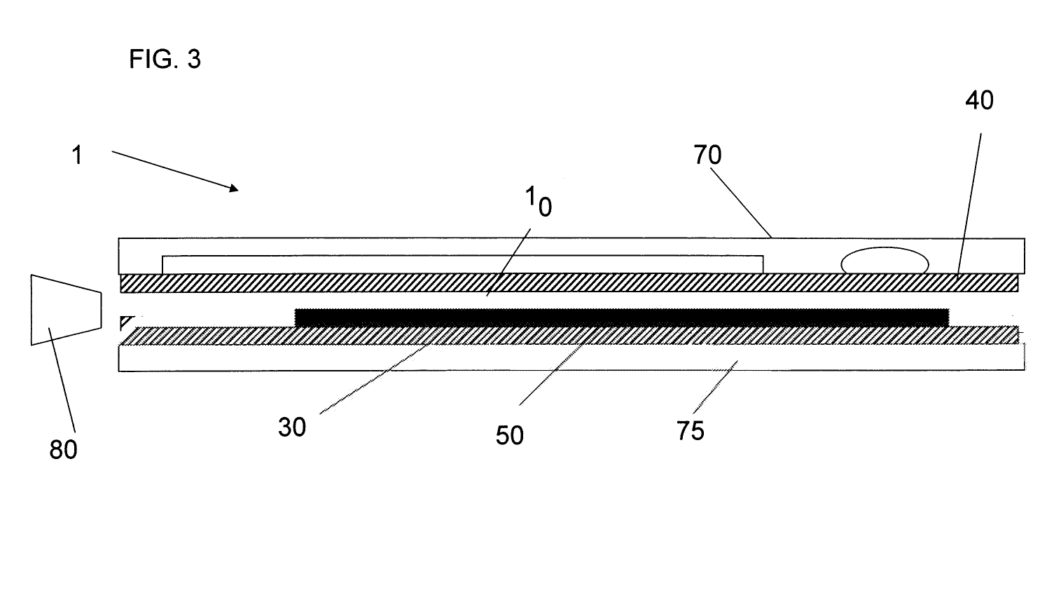

First, a bottom layer 30 is provided. The bottom layer 30 has a top surface 31 and a bottom surface 32. Then, the power source 10 is attached. As shown in FIG. 3, the bottom layer 30 is then loaded as one complete sheet into an injection molding apparatus.

A top layer 40 is placed into the injection molding apparatus and positioned such that the top layer 40 is above the top surface 31 of the bottom layer 30. Specifically, the injection molding apparatus may be a reaction injection molding machine (which is often individually referred to as “RIM”). These machines are associated with a top mold shell 70 and a bottom mold shell 75 that are capable of performing cold, low pressure, forming operations on at least one of the sheets of polymeric material (e.g., PVC) that make up the top 40 and bottom 30 layers. Such top and bottom mold shells 70, 75 cooperate in ways that are well known to those skilled in the polymeric material molding arts.

The injection molding apparatus then injects thermosetting polymeric material via a nozzle 80 (shown in FIG. 3) between the top layer 40 and the bottom layer 30 forming the core layer 50 from thermosetting polymeric material.

Cold, low pressure forming conditions generally mean forming conditions wherein the temperature of the core layer 50 consisting of thermosetting polymeric material, is less than the heat distortion temperature of the top 40 and bottom 30 layers, and the pressure is less than about 500 psi. Preferably, the cold forming temperatures will be at least 10° F. less than the heat distortion temperature of the top 40 and bottom 30 overlays. The heat distortion temperature of many polyvinyl chloride (PVC) materials is about 230° F.

Preferably, gates are employed that are tapered down from a relatively wide inflow area to a relatively narrow core region that ends at or near the leading edge(s) of the power bracelet 1 body being formed. Most preferably, these gates will narrow down from a relatively wide diameter (e.g., from about 5 to about 10 mm) injection port that is in fluid connection with the thermosetting material-supplying runner, to a relatively thin diameter (e.g., 0.10 mm) gate/bracelet edge where the gate feeds the thermosetting material into the void space which ultimately becomes the center or core of the finished power bracelet 1. Gates that taper from an initial diameter of about 7.0 millimeters down to a minimum diameter of about 0.13 mm will produce especially good results under the preferred cold, low-pressure injection conditions.

Another optional feature that can be used is the use of mold shells that have one or more receptacles for receiving “excess” polymeric material that may be purposely injected into the void space between the top 40 and bottom 30 layers in order to expunge any air and/or other gases (e.g., those gases formed by the exothermic chemical reactions that occur when the ingredients used to formulate most polymeric thermoset materials are mixed together) from said void space. These thermoset ingredients are preferably mixed just prior to (e.g., about 30 seconds before) their injection into the void space.

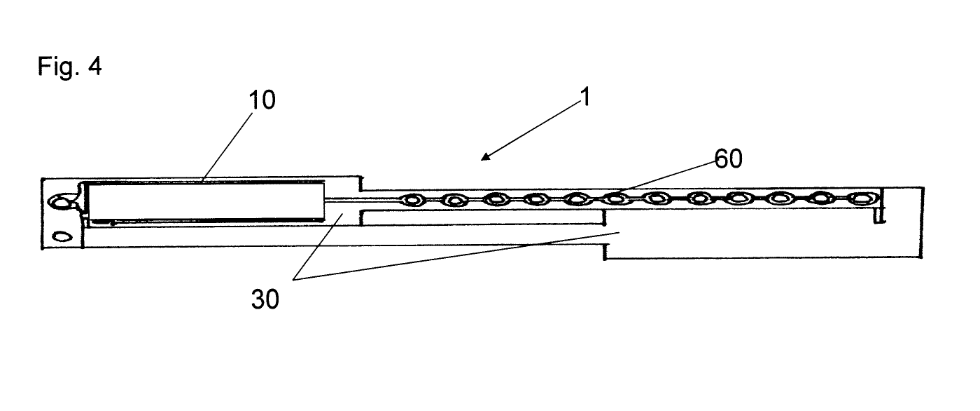

Once the core layer 50 has been injected, the molded structure is removed from the injection molding apparatus. According to one embodiment of the invention, several power bracelets 1 are cut out of one molded sheet. FIG. 4 depicts several power bracelets 1 formed on one sheet. The finished power bracelets 1 are then removed from the excess polymeric material (e.g., by trimming) and cut to certain prescribed sizes. The trimming process may also remove the excess material in one cutting/trimming operation. It also will be well appreciated by those skilled in this art that the molding devices used to make such power bracelets 1 in commercial production operations will most preferably have mold shells having multiple cavities (e.g., 2, 4, 6, 8, etc.) for making several such power bracelets 1 simultaneously.

According to one embodiment of the invention, as shown in FIG. 5, the detachable electronic package 20 consists of a housing 203, registration pins 201, a clip 204 and electronic package contacts 202. The electronic package 20 is positioned on the top layer 40 so that the registration pins 101 are inserted securely into the registration recesses 101. This insures that the electronic packages 202 properly line up with and come in contact with the contacts 102 of the power source 10. A clip 204 connects the detachable electronic package 20 to the top layer 40 of the top surface 41 of the power bracelet 1. The clip 204 slides underneath the power bracelet 1 and once attached remain on the power bracelet 1 until the user disengages the clip 204.

According to another embodiment of the invention, as shown in FIG. 6, the detachable electronic package 20 consists of a housing 203, registration pins 201 and contacts 202. According to one embodiment, pressure sensitive adhesive, cyanoacrylate or other quick set adhesive connects the detachable electronic package 20 to the top surface 41 of the top layer 40 of the power bracelet 1. This adhesive temporarily connects the detachable electronic package 20 to the power bracelet 1 but is easily removable. The adhesive may be a strip that has no-stick surfaces placed on either side of the adhesive strip that prevents the adhesive from easily attaching to surfaces. For example, when a user is ready to place the detachable electronic package 20 on the power bracelet 1 the user can remove one no-stick surface and place it on the desired detachable electronic package 20 location. The electronic package 20 is positioned above the top layer 40 so that the electronic package contacts 202 properly line up with and come in contact with the power source contacts 102 of the power source 10. Next, the other no-stick surface is removed and the electronic package 20 can be lowered in place such that the contacts 102, 202 are operably connected.

The present invention has several advantages including a cost effective manner to produce one or more RFID power bracelets 1. The core layer 50 provides greater protection to circuit components inside the power bracelet 1 during manufacturing and wear which in turn lowers production costs and raises production output. Moreover, the method of the present invention can be easily adapted to produce multiple power bracelets 1 at once.

The removable electronic package affords the power bracelet a great deal of flexibility and can be useful in various applications. For example, the power bracelets can be used to track users, patrons, patients, etc. That is, the electronic package can be configured to communicate a with central communications network for tracking and monitoring purposes. When the power source on the bracelet 1 is depleted, the power source can be easily replaced without having to obtain and configure a new electronic package. Thus, by making the electronic package independent from a power source, the longevity of the electronic package is increased and thus the flexibility of a system using the power bracelet is increased.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. A power bracelet comprising:
a bottom layer having a top surface and a bottom surface;
a power source attached to the top surface of the bottom layer;
a core layer, positioned above the bottom layer and attached to the bottom layer; and
a top layer, positioned above the core layer, wherein the top layer is configured to receive a detachable electronic package capable of operatively connecting to the power source.

2. The power bracelet of claim 1, further comprising at least one recess on one of the longitudinal edges of the power bracelet, wherein the recess is configured to properly align the electronic package with the top layer.

3. The power bracelet of claim 1, wherein the bottom layer and the top layer are comprised of non-conductive plastic material.

4. The power bracelet of claim 1, wherein the core layer is comprised of thermosetting polymeric material.

5. The power bracelet of claim 1, further comprising a plurality of extremity loops for fastening the power bracelet to a wrist of a wearer.

6. The power bracelet of claim 1, wherein the power source is a battery.

7. The power bracelet of claim 1, wherein the electronic package comprises:
a housing, wherein the housing encloses:
an antenna; and
a radio frequency identification microprocessor operably connected to the antenna; and
a plurality of contacts for operably connecting the electronic package to the power source.

8. The power bracelet of claim 7, wherein the electronic package further comprises a plurality of registration pins, wherein the registration pins are configured to be received by at least one recess on one of the longitudinal edges of the power bracelet, wherein the recess is configured to properly align the electronic package with the top layer.

9. The power bracelet of claim 7, wherein the electronic package includes a clip for attaching the electronic package to the top layer and the bottom layer of the power bracelet.

10. The power bracelet of claim 7, wherein the electronic package has an adhesive surface for attaching the electronic package to the top layer of the power bracelet.

11. The power bracelet of claim 7 wherein the radio frequency identification microprocessor is a SL2 ICS20 microprocessor chip.

12. A method for manufacturing a power bracelet comprising:
providing a bottom layer having a top surface and a bottom surface;
attaching a power source to the top surface of the bottom layer;
loading the bottom layer into an injection molding apparatus;
loading the top layer, positioned above the top surface of the bottom layer, into the injection molding apparatus; and
injecting thermosetting polymeric material between the top layer and the top surface of the bottom layer.

13. The method of claim 12, wherein the power source is attached to the bottom layer using a pressure sensitive adhesive or cyanoacrylate or other quick set adhesive.

14. The method of claim 12, further comprising forming a plurality of extremity loops on the power bracelet for fastening the wristband to the wrist of a wearer.

15. The method of claim 12 further comprising formatting an edge of one longitudinal side of the bracelet with at least one recess, wherein the recess is configured to align the electronic package with the top layer.

16. The method of claim 12, further comprising the step of:
attaching an electronic package to the top layer, wherein the electronic package is operably connected to the power source so that the electronic package receives power from the power source.

17. The method of claim 16, wherein the electronic package comprises:
a housing, wherein the housing encloses:
an antenna; and
a radio frequency identification microprocessor operably connected to the antenna; and
a plurality of contacts for operably connecting the electronic package to the power source.

18. The method of claim 16, wherein the electronic package further comprises a plurality of registration pins, wherein the registration pins are configured to be received by at least one recess on one of the longitudinal edges of the power bracelet, wherein the recess is configured to properly align the electronic package with the top layer.

19. The method of claim 16, wherein the electronic package includes a clip for attaching the electronic package to the top layer and the bottom layer of the power bracelet.

20. The method of claim 16, wherein the electronic package has an adhesive surface for attaching the electronic package to the top layer of the power bracelet.
